(19) United States
(12) Patent Application Publication
(10) Pub. No.: US 2026/0261011 A1
(43) Pub. Date: Sep. 3, 2026

(54) RECHARGEABLE BATTERY AND BATTERY PACK INCLUDING THE SAME

(71) Applicant: SAMSUNG SDI CO., LTD., Yongin-si (KR)

(72) Inventors: Sun A LEE, Suwon-si (KR); Min Hee KIM, Suwon-si (KR); Seung Woo LEE, Suwon-si (KR); Hui Jeong CHO, Suwon-si (KR); Han Woong CHO, Suwon-si (KR)

(73) Assignee: SAMSUNG SDI CO., LTD., Yongin-si (KR)

(21) Appl. No.: 19/552,685

(22) Filed: Feb. 27, 2026

(30) Foreign Application Priority Data
Feb. 28, 2025 (KR) 10-2025-0026704

(51) Int. Cl. H01M 50/42; H01M 10/0525; H01M 10/0567; H01M 10/0569; H01M 10/0587; H01M 50/105; H01M 50/489

(52) U.S. Cl. CPC H01M 50/42; H01M 10/0525; H01M 10/0567; H01M 10/0569; H01M 10/0587; H01M 50/105; H01M 50/489

(57) ABSTRACT

The present disclosure relates to a rechargeable battery, and a battery pack including the rechargeable battery. The rechargeable battery includes an electrode assembly having a first electrode plate, a second electrode plate, and a separator interposed between the first electrode plate and the second electrode plate, and an electrolyte with which the electrode assembly is impregnated. The separator includes a substrate and an adhesive layer located on at least one surface of the substrate. The adhesive layer includes a copolymer of a monomer mixture including an unsaturated monomer having a carboxylic acid group or a salt thereof and an unsaturated monomer having an aromatic group. The copolymer having a glass transition temperature of 90 to 150° C., and the electrolyte includes a non-aqueous organic solvent.

### CROSS-REFERENCE TO RELATED APPLICATION

The present application claims priority and the benefit of Korean Patent Application No. 10-2025-0026704, filed on Feb. 28, 2025 in the Korean Intellectual Property Office, the entire disclosure of which is incorporated herein by reference.

### BACKGROUND

### 1. Field of the Disclosure

The present disclosure relates to a rechargeable battery, and a battery pack including the rechargeable battery.

### 2. Discussion of Related Art

With increasing presence of electronic devices such as, e.g., mobile phones, notebook computers, electric vehicles, and the like, that use batteries, the demand for secondary batteries having high energy density and high capacity is increasing. Therefore, improving the performance of rechargeable lithium batteries may be advantageous.

A rechargeable lithium battery includes a positive electrode and a negative electrode that contain an active material capable of the intercalation and deintercalation of lithium ions, and produces electric energy by oxidation and reduction reactions when the lithium ions are intercalated into and deintercalated from the positive electrode and the negative electrode.

### SUMMARY

One example embodiment is directed to a rechargeable battery with reduced film formation of an adhesive layer of a separator after a long period of time in the battery.

Another example embodiment is directed to a rechargeable battery in which a change in the air permeability of a separator is low after a long period of time in the battery.

Still another example embodiment is directed to a rechargeable battery including a separator in which there is substantially no adhesion between separators and substantially no separation of an adhesive layer from the separator when the wound separator is withdrawn.

However, objects of the present disclosure are not limited to the above objects, and other objects that are not specifically mentioned herein may be clearly understood by those skilled in the art based on the description of the present disclosure below.

According to one example embodiment, a rechargeable battery includes an electrode assembly having a first electrode plate, a second electrode plate, and a separator interposed between the first electrode plate and the second electrode plate, and an electrolyte with which the electrode assembly is impregnated. The separator includes a substrate and an adhesive layer located on at least one surface of the substrate. The adhesive layer includes a copolymer of a monomer mixture including an unsaturated monomer having a carboxylic acid group or a salt thereof and an unsaturated monomer having an aromatic group. The copolymer has a glass transition temperature in a range of about 90° C. to about 150° C., and the electrolyte includes a non-aqueous organic solvent in which an ethylene carbonate:dimethyl carbonate:ethyl methyl carbonate volume ratio is in a range of about 20% to 30%:30% to 40%:30% to 40% based on the total volume of 100%.

### BRIEF DESCRIPTION OF THE DRAWINGS

The following drawings attached to the present specification illustrate example embodiments of the present disclosure and further describe aspects and features of the present disclosure together with the detailed description of the present disclosure. Thus, the present disclosure should not be construed as being limited to the drawings, in which:

FIG. 1 is a schematic perspective view showing a pouch-type rechargeable battery according to one example embodiment;

FIG. 2 is a cross-sectional view of a separator according to one example embodiment;

FIG. 3 is a schematic cross-sectional view showing a cylindrical rechargeable battery according to one example embodiment;

FIG. 4 is a schematic cross-sectional view showing a prismatic rechargeable battery according to one example embodiment, and

FIG. 5 is a schematic perspective view showing a pouch-type rechargeable battery according to one embodiment.

### DETAILED DESCRIPTION

Hereinafter, example embodiments of the present disclosure are described, in detail, with reference to the accompanying drawings. Terms or words used in this specification and claims should not be interpreted as limited to their usual or dictionary meanings and should be interpreted as meanings and concepts that conform to the technical idea of the present disclosure. The example embodiments described in this specification and the configurations shown in the drawings are only some example embodiments of the present disclosure and do not represent all of the technical ideas of the present disclosure. Accordingly, it should be understood that there may be various equivalents and modifications that can replace the example embodiments at the time of filing this application. In addition, when used in the present specification, “comprise” and “include” and/or “comprising” and “including” specify the presence of the stated shapes, numbers, steps, operations, members, elements, and/or groups thereof and do not preclude the presence or addition of one or more other shapes, numbers, steps, operations, members, elements, and/or groups thereof. In addition, in the description of example embodiments of the present disclosure, “may” and “may be” may include “one or more embodiments of the present disclosure.”

In addition, to facilitate understanding of the disclosure, the accompanying drawings may not be drawn to scale, and the dimensions of some components may be shown in an exaggerated manner. In addition, the same reference numbers may denote the same components in different embodiments.

When two objects of comparison are “the same,” it means that the two objects are “substantially the same.” Accordingly, “substantially the same” may include a deviation that is considered low in the art, for example, a deviation within 5%. In addition, uniformity of a parameter over a given region may mean uniformity from the viewpoint of an average.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, when a certain component is described as being “connected,” “coupled,” or “joined” to the other component, it should be understood that the components may be directly connected or coupled to one another, but that other components may also be “interposed” between the components, or that the components may be “connected,” “coupled,” or “joined” through another component. In addition, when a certain component is described as being “electrically coupled to” the other component, this includes not only a case in which the certain component is “directly coupled” to the other component, but also a case in which the certain component is “coupled” to the other component with another component interposed therebetween.

When referring to “A and/or B” throughout the specification, this means A, B or A and B unless otherwise specified. That is, the term “and/or” includes all or any combination of the plurality of listed items. When referring to “C to D,” this means C or more and D or less unless otherwise specified.

When phrases such as “at least one of A, B, and C, “at least one of A, B, or C,” are used to designate a list of elements A, B, and C, the phrase may refer to any and all suitable combinations thereof.

The terms “use” may be considered synonymous with the terms “utilize.” As used herein, the terms “substantially,” “about,” and similar terms are used as terms of approximation and not as terms of degree and are intended to account for the inherent variations in measured or calculated values that would be recognized by those of ordinary skill in the art.

It may be understood that, although the terms first, second, third, and the like, may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be named a second element, component, region, layer, or section without departing from the teachings of example embodiments.

Spatially relative terms, such as “beneath,” “below,” “lower,” “above,” “upper,” and the like, may be used herein for ease of description to describe a relationship of one element or feature to (an) other element(s) or feature(s) as illustrated in the drawings. It may be understood that the spatially relative terms are intended to encompass different orientations of the device in use or operation in addition to the orientations depicted in the drawings. For example, if a device in the drawings is turned over, elements described as “below” or “beneath” other elements would then be understood to be “above” or “over” the other elements. Thus, the term “below” may encompass both an orientation of above and below.

The terminology used herein is intended to describe example embodiments of the present disclosure and is not intended to limit the present disclosure.

Hereinafter, a rechargeable battery and a battery pack including the rechargeable battery according to various example embodiments of the present disclosure are described with reference to the accompanying drawings. In this description, thicknesses of lines, sizes of components, and the like, shown in the drawings may be exaggerated for clarity and convenience of the description. In addition, terms to be described below are the terms defined in consideration of functions in the present disclosure, which may be changed according to a user or operator's intention or custom. Accordingly, the definition of these terms should be made based on the contents throughout the specification.

In the present specification, “particle diameter D50” is an average particle diameter that is a diameter of particles having a cumulative volume of 50% by volume in the particle size distribution. The particle size distribution may be measured by methods known to those skilled in the art. For example, the particle size distribution can be measured using a particle size analyzer, a transmission electron microscope, or a scanning electron microscope. As another method, the particle size distribution can be measured using a measuring device that uses dynamic light-scattering, and data analysis can be performed to count the number of particles within a range of each particle size, and then a D50 value can be obtained therefrom. Alternatively, the particle size distribution can be measured using a laser diffraction method. When measurement is performed using a laser diffraction method, for example, after particles to be measured are dispersed in a dispersion medium, the dispersion medium is introduced into a commercially available laser diffraction particle size measuring device (e.g., Microtrac MT 3000) and irradiated with ultrasonic waves of about 28 kHz at an output of 60 W, and then the D50 based on 50% of the particle size distribution in the measuring device can be calculated.

In the present specification, “particle diameter D100” is diameter of particles having a cumulative volume of 100% by volume in the particle size distribution and may be measured based on the measurement of the particle diameter D50.

In the description of a numerical range in the present specification, “X to Y” means “X or more and Y or less (X≤and ≤Y).

When the terms “about” or “substantially” are used in this specification in connection with a numerical value, it is intended that the associated numerical value include a tolerance of ±10% around the stated numerical value. When ranges are specified, the range includes all values therebetween such as increments of 0.1%.

According to the present disclosure, the lifetime of a battery is extended by reducing or preventing an increase in resistance of a separator by reducing the film formation of an adhesive layer of the separator after a long period of time in the battery. According to the present disclosure, reliability is improved by extending the lifetime of the separator by reducing the change in the air permeability of the separator after a long period of time in the battery. According to the present disclosure, battery manufacturing processability is improved by including a separator in which there is no adhesion between separators and no separation of an adhesive layer from the separator when the wound separator is withdrawn.

According to one example embodiment, a rechargeable battery includes an electrode assembly having a first electrode plate, a second electrode plate, a separator interposed between the first electrode plate and the second electrode plate, and an electrolyte with which the electrode assembly is impregnated. The separator includes a substrate and an adhesive layer located on at least one surface of the substrate. The adhesive layer includes a copolymer of a monomer mixture including an unsaturated monomer having a carboxylic acid group or a salt thereof, and an unsaturated monomer having an aromatic group, the copolymer having a glass transition temperature in a range of about 90° C. to about 150° C., and the electrolyte includes a non-aqueous organic solvent in which an ethylene carbonate:dimethyl carbonate:ethyl methyl carbonate volume ratio is in a range of about 20% to 30%:30% to 40%:30% to 40% based on the total volume of 100%.

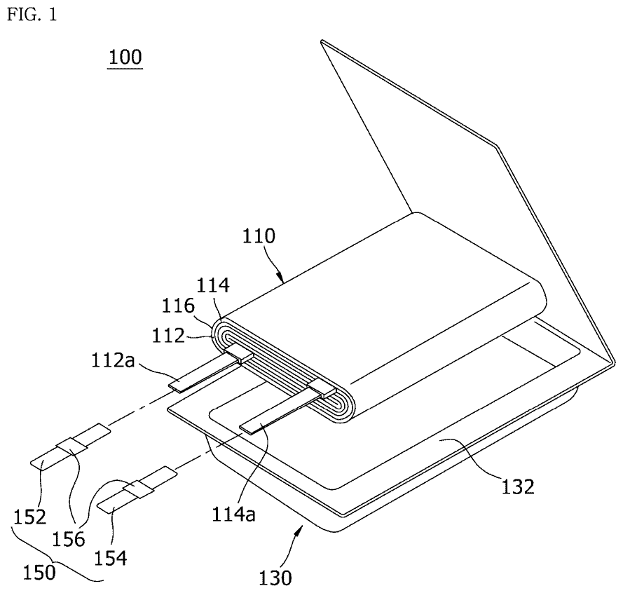

FIG. 1 is a perspective view of a rechargeable battery according to one example embodiment of the present disclosure.

Referring to FIG. 1, a pouch-type rechargeable battery 100 may include an electrode assembly 110 and a pouch 130 accommodating the electrode assembly 110.

The electrode assembly 110 may be formed by winding or stacking a stack of a first electrode plate 112, a separator 116, and a second electrode plate 114, which is formed in the form of a thin plate or a film.

When the electrode assembly 110 is a wound stack, a winding axis may be parallel to a longitudinal direction of a sealing part. In addition, the electrode assembly 110 may be a stack type rather than a wound type, and the shape of the electrode assembly is not limited in the present disclosure.

In addition, the electrode assembly 110 may be or include a Z-stack electrode assembly in which the first electrode plate and the second electrode plate are inserted on both sides of a separator bent in a Z-stack shape.

One or more electrode assemblies 110 may be stacked such that long sides are adjacent to each other and accommodated in the sealing part, and the number of electrode assemblies is not limited in the present disclosure.

The electrode assembly 110 is impregnated with an electrolyte (not shown) accommodated in the pouch 130.

By including the separator 116 described below, the lithium rechargeable battery can have desired or improved manufacturing processability because there is no adhesion, or substantially no adhesion, between separators and no separation, or substantially no separation, of an adhesive layer from the separator. By including the separator and the electrolyte, which are described below, the lithium rechargeable battery can have an extended lifetime by reducing or preventing an increase in the resistance of the separator by reducing the film formation of an adhesive layer of the separator even after long-term exposure, and have desired or improved battery reliability by extending the lifetime of the separator by reducing the change in air permeability. Film formation may occur on the separator when impregnated with the electrolyte. When film formation occurs on the separator, pores in the separator are blocked, hindering the movement of lithium ions and thus increasing resistance. In addition, the change in the air permeability of the separator may increase when impregnated with the electrolyte. This may also increase the resistance by blocking the normal movement of lithium ions in the separator.

Hereinafter, the separator is described in detail.

### Separator:

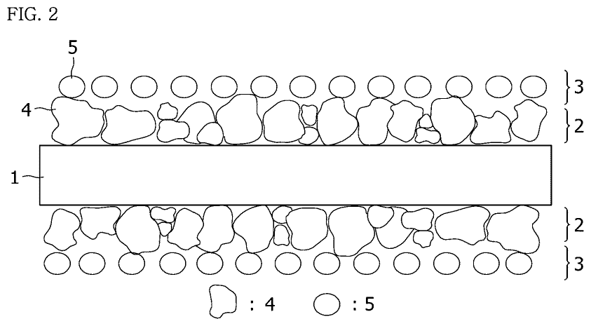

Referring to FIG. 2, the separator includes a substrate 1, and a heat-resistant layer 2 and an adhesive layer 3 located, or sequentially located, on both surfaces of the substrate 1, and the adhesive layer 3 includes a copolymer 5.

FIG. 2 shows the heat-resistant layer 2 and the adhesive layer 3 sequentially located on both surfaces of the substrate 1, but the present disclosure is not limited thereto. The separator including the substrate 1 and the heat-resistant layer 2 and the adhesive layer 3 sequentially located on one surface of the substrate 1 may also be included in the battery of the present disclosure.

### Adhesive Layer

The adhesive layer 3 includes the copolymer 5 of a monomer mixture including an unsaturated monomer having a carboxylic acid group or a salt thereof and an unsaturated monomer having an aromatic group, and the copolymer 5 has a glass transition temperature in a range of about 90° C. to about 150° C.

The copolymer 5 may have desired or improved adhesion to the first electrode plate 112 or the second electrode plate 114, and when the wound separator is unwound, the copolymer 5 can reduce or prevent adhesion between the separators and separation of the adhesive layer from the separator, reduce the film formation of the adhesive layer of the separator after a long period of time in the battery, and reduce the change in the air permeability of the separator after a long period of time in the battery.

When the glass transition temperature of the copolymer is about 90° C. or higher, it is possible to reduce or prevent the separation of the adhesive layer from the separator when the separator is withdrawn from a winder to manufacture a rechargeable battery after winding, and to readily reduce the film formation of the adhesive layer of the separators and reduce the change in the air permeability of the separator after long-term exposure to the electrolyte to be described below. When the glass transition temperature of the copolymer is about 150° C. or lower, it is possible to implement desired or improved adhesion within the separator, reduce or prevent the separation of the adhesive layer from the separator when the separator is withdrawn from a winder to manufacture a rechargeable battery after winding, and readily reduce the film formation of the adhesive layer within the separator and reduce the change in the air permeability of the separator after long-term exposure to the electrolyte to be described below.

For example, the glass transition temperature of the copolymer may be 90, 91, 92, 93, 94, 95, 96, 97, 98, 99, 100, 101, 102, 103, 104, 105, 106, 107, 108, 109, 110, 111, 112, 113, 114, 115, 116, 117, 118, 119, 120, 121, 122, 123, 124, 125, 126, 127, 128, 129, 130, 131, 132, 133, 134, 135, 136, 137, 138, 139, 140, 141, 142, 143, 144, 145, 146, 147, 148, 149, 150° C., or range from about 90° C. to about 130° C., or 90 to 110° C. In the above range, along with the above effects, even after multiple charge/discharge cycles in the battery, a high discharge capacity recovery rate can be maintained, which may lead to desired or improved battery performance.

The glass transition temperature of the copolymer may be measured by a method known to those skilled in the art using a differential scanning calorimeter (DSC). For example, an inflection point of an endothermic transition curve may be determined to be a glass transition temperature after data is obtained from the endothermic transition curve that is generated when heating a sample up to about 180° C. at a rate of about 20° C./min, gradually cooling the sample down to about −100° C., and then reheating the sample to about 100° C. at a rate of about 10° C./min.

A copolymer of a monomer mixture having a glass transition temperature in a range of about 90° C. to about 150° C. but lacking one of an unsaturated monomer having a carboxylic acid group, or a salt thereof, and an unsaturated monomer having an aromatic group cannot provide all of the above effects.

The copolymer 5 can readily reduce the film formation of the adhesive layer in the battery when the heat-resistant layer 2 to be described below is positioned, and reduce the change in the air permeability of the separator after a long period of time in the battery.

The copolymer 5 shown in FIG. 2 includes a unit derived from an unsaturated monomer having a carboxylic acid group or a salt thereof, and a unit derived from an unsaturated monomer having an aromatic group.

The unsaturated monomer having a carboxylic acid group or a salt thereof may be represented by any one of the following Chemical Formulas 1 to 3.

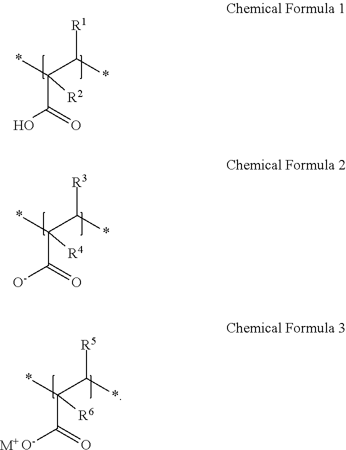

In Chemical Formulas 1 to 3,
* is a connecting portion of an element,
R¹ to R⁶ are each independently hydrogen or a C1 to C10 alkyl group, and
M is or includes an alkali metal.

For example, in Chemical Formulas 1 to 3, R¹ to R⁶ may each be hydrogen or a methyl group.

In one example, the unsaturated monomer having a carboxylic acid group or a salt thereof may be (meth)acrylic acid or the like.

The unsaturated monomer having a carboxylic acid group or a salt thereof may be included in an amount in a range of about 0.5 mol % to about 99 mol %, for example, 0.5, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 59, 60, 61, 62, 63, 64, 65, 66, 67, 68, 69, 70, 71, 72, 73, 74, 75, 76, 77, 78, 79, 80, 81, 82, 83, 84, 8 5, 86, 87, 88, 89, 90, 91, 92, 93, 94, 95, 96, 97, 98.99 mol %, 0.5 mol % to 30 mol %, for example, 1 to 10 mol % in the monomer mixture. In the above range, high adhesion to the first electrode plate or the second electrode plate can be maintained.

The unsaturated monomer having an aromatic group may be represented by the following Chemical Formula 4.

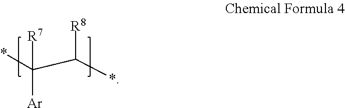

In Chemical Formula 4,
* is a connecting portion of an element,
R⁷ and R⁸ are each independently hydrogen or a substituted or unsubstituted C1 to C5 alkyl group, and
Ar is or includes a substituted or unsubstituted, monocyclic or polycyclic C6 to C20 aryl group).

In one example, in Chemical Formula 4, Ar is or includes a monocyclic or polycyclic C6 to C20 aryl group, for example, at least one of a phenyl group, a naphthalenyl group, an anthracenyl group, a pyrenyl group, and the like.

In one example, the unsaturated monomer having an aromatic group may be represented by the following Chemical Formula 5.

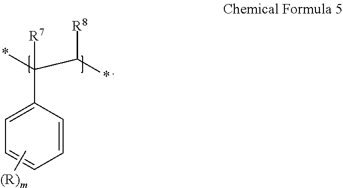

In Chemical Formula 5,
* is a connecting portion of an element,
R⁷ and R⁸ are each independently hydrogen or a substituted or unsubstituted C1 to C5 alkyl group,
R is or includes at least one of a substituted or unsubstituted C1 to C20 alkyl group, a substituted or unsubstituted C3 to C20 cycloalkyl group, a substituted or unsubstituted C1 to C20 alkoxy group, a substituted or unsubstituted C3 to C20 aryl group, a halogen, and a substituted or unsubstituted C2 to C20 alkenyl group, and
m is an integer ranging from 0 to 5.

In one example, in Chemical Formula 5, R may be or include a substituted or unsubstituted C1 to C20 alkyl group, a halogen, or a substituted or unsubstituted C1 to C20 alkoxy group. In one example, in Chemical Formula 5, m may be equal to 0 or 1.

For example, the unsaturated monomer having an aromatic group may be or include one or more of styrene, alpha-methyl styrene, 4-butyl styrenes including 4-n-butyl styrene, 4-iso-butyl styrene, 4-t-butyl styrene, and the like, butoxy styrenes including 4-butoxy styrenes including 4-n-butoxy styrene, 4-iso-butoxy styrene, 4-t-butoxy styrene, and the like, halo styrenes including chloro styrene, bromo styrene, fluoro styrene, and the like, vinyl toluenes including 4-vinyl toluene, 3-vinyl toluene, 2-vinyl toluene, and the like, vinyl naphthalenes including 1-vinyl naphthalene, 2-vinyl naphthalene, and the like.

For example, the unsaturated monomer having an aromatic group may include one or more of styrene and alpha-methyl styrene.

The unsaturated monomer having an aromatic group may be included in an amount in a range of about 1 mol % to about 99.5 mol %, for example, 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, 50, 51, 52, 53, 54, 55, 56, 57, 58, 5 9, 60, 61, 62, 63, 64, 65, 66, 67, 68, 69, 70, 71, 72, 73, 74, 75, 76, 77, 78, 79, 80, 81, 82, 83, 84, 85, 86, 87, 88, 89, 90, 91, 92, 93, 94, 95, 96, 97, 98.99 mol %, 0.5 mol % to 40 mol %, for example, 1 mol % to 30 mol % in the monomer mixture. In the above range, there may be a binder glass transition temperature (Tg) increasing effect.

In one example, a mixture of the unsaturated monomer having a carboxylic acid group or a salt thereof and the unsaturated monomer having an aromatic group may be included in an amount in a range of about 50 mol % or more, for example, 50, 51, 52, 53, 54, 55, 56, 57, 58, 59, 60, 61, 62, 63, 64, 65, 66, 67, 68, 69, 70, 71, 72, 73, 74, 75, 76, 7 7, 78, 79, 80, 81, 82, 83, 84, 85, 86, 87, 88, 89, 90, 91, 92, 93, 94, 95, 96, 97, 98, 99, 100 mol %, about 50 mol % to about 100 mol %, 95 mol % to 100 mol %, or 100 mol % in the monomer mixture.

The copolymer may further include a unit derived from an (meth)acryl-based monomer containing an alkyl group having a range of 1 to 10 carbon atoms in the main chain at the ester moiety. The unit can facilitate the control of the adhesion and glass transition temperature of the adhesive layer.

The (meth)acryl-based monomer may be represented by the following Chemical Formula 6.

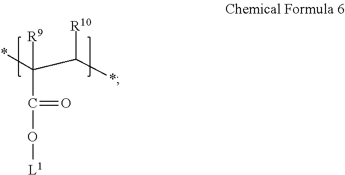

In Chemical Formula 6,
* is a connecting portion of an element,
R⁹ and R¹⁰ are each independently hydrogen or a methyl, and
L¹ is or includes a substituted or unsubstituted, straight-chain or branched-chain C1 to C10 alkyl group.

In one example, the (meth)acryl-based monomer may include one or more of methyl (meth)acrylate, ethyl (meth)acrylate, n-propyl (meth)acrylate, iso-propyl (meth)acrylate, n-butyl (meth)acrylate, iso-butyl (meth)acrylate, tert-butyl (meth)acrylate, n-pentyl (meth)acrylate, n-hexyl (meth)acrylate, and 2-ethylhexyl (meth)acrylate.

For example, the (meth)acryl-based monomer may include one or more of n-butyl (meth)acrylate and 2-ethylhexyl (meth)acrylate.

The (meth)acryl-based monomer may be included in an amount in a range of about 50 mol % to about 99 mol %, for example, 50, 51, 52, 53, 54, 55, 56, 57, 58, 59, 60, 61, 62, 63, 64, 65, 66, 67, 68, 69, 70, 71, 72, 73, 74, 75, 76, 7 7, 78, 79, 80, 81, 82, 83, 84, 85, 86, 87, 88, 89, 90, 91, 92, 93, 94, 95, 96, 97, 98.99 mol %, 60 mol % to 98 mol % in the monomer mixture. In the above range, the adhesive properties of the separator may be exhibited.

In one example, a mixture of the unsaturated monomer having a carboxylic acid group or a salt thereof, the unsaturated monomer having an aromatic group, and the (meth)acryl-based monomer may be included in an amount of about 95 mol % or more, for example, a range of about 95 mol % to about 100 mol %, 95 mol % to 100 mol %, or 100 mol %, in the monomer mixture.

The copolymer may include an alkali metal. The alkali metal may be present in the form of a cation and for example, may be or included at least one of lithium, sodium, potassium, rubidium, or cesium. For example, the alkali metal may be present in the form of a salt when combined with the copolymer. The alkali metal may assist in the synthesis of the copolymer in an aqueous solvent, improve the adhesion of the adhesive layer, and improve the heat resistance, air permeability, and oxidation resistance of the separator.

The alkali metal may be included in an amount in a range of about 1 mol % to about 40 wt % of the alkali metal and the copolymer, for example, 1 to 30 wt %, 1 to 20 wt %, or 10 to 20 wt %. For example, the copolymer and the alkali metal may be included at a weight ratio in a range of about 99:1 to about 60:40, a weight ratio of 99:1 to 70:30, for example, a weight ratio of 99:1 to 80:20, for example, a weight ratio of 90:10 to 80:20.

The alkali metal may be included in an amount in a range of about 0.1 mol % to about 1.0 mol % based on the total content of the alkali metal and the copolymer. When the alkali metal is included within the above range, the adhesive layer can have desired or improved adhesion, and a separator including the adhesive layer can exhibit desired or improved heat resistance, air permeability, and oxidation resistance.

The copolymer may have various forms, such as an alternating polymer in which the structural units are alternately distributed, a random polymer in which the structural units are randomly distributed, a graft polymer in which some of the structural units are grafted, and the like.

The weight average molecular weight of the copolymer may range from about 100,000 g/mol to about 1,000,000 g/mol, 100,000 to 500,000 g/mol, 100,000 to 150,000 g/mol, 200,000 to 130,000 g/mol, or 300,000 to 900,000 g/mol. When the weight average molecular weight of the copolymer satisfies the above range, desired or improved adhesion and low resistance can be exhibited. The weight average molecular weight may be a polystyrene-converted average molecular weight measured using, e.g., gel permeation chromatography (GPC).

The copolymer may be prepared by a solution polymerization method.

According to one example embodiment, the copolymer is a particle-type adhesive binder, and an average particle diameter D50 may range from about 0.1 μm to about 1.0 μm, for example, 0.1, 0.2, 0.3, 0.4, 0.5, 0.6, 0.7, 0.8, 0.9, 1.0 1.0 μm, 0.3 to 1.0 μm. The above range may facilitate the formation of an adhesive layer.

A thickness of the adhesive layer 3 may range from about 0.1 μm to about 5 μm, for example, 0.1 to 3 μm.

### Heat-Resistant Layer

The heat-resistant layer 2 may reduce a thermal shrinkage rate of the separator by including a filler 4.

The filler 4 may include one or more of an inorganic filler and an organic filler.

The organic filler may include a crosslinked polymer filler. The crosslinked polymer filler may reduce a moisture content, thereby further reducing the thermal shrinkage rate of the separator and improving insulation properties. The crosslinked polymer filler may be included in a combination of the (meth)acryl-based binder and the inorganic filler, thereby facilitating a reduction of the thermal shrinkage rate of the separator.

The inorganic filler may be or include a ceramic material. For example, the inorganic filler may include, for example, at least one of a metal oxide, a metalloid oxide, a metal fluoride, a metal hydroxide, or a combination thereof. The inorganic filler may include, for example, at least one of alumina (e.g., Al₂O₃), SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, or a combination thereof, but is not limited thereto.

The filler 4 may have an average particle diameter D50 in a range of about 20 nm to about 300 nm, for example, 50 to 200 nm, 50 to 150 nm.

The filler 4 may have a plate, spherical, cubic shape, or a combination thereof. For example, the filler may have a spherical shape.

The filler 4 may be included in an amount of about 50 wt % or more of the heat-resistant layer 2, for example, a range of about 50 wt % to about 99 wt %, for example, 70 wt % to 99 wt %, for example, 75 wt % to 99 wt %, for example, 80 wt % to 99 wt %, for example, 85 wt % to 99 wt %, for example, 90 wt % to 99 wt %, for example, 95 wt % to 99 wt %. When the filler is included within the above range, the separator can exhibit desired or improved heat resistance, durability, oxidation resistance, and stability.

The heat-resistant layer 2 may further include a binder, for example, a (meth)acryl-based binder.

The heat-resistant layer 2 may have a thickness in a range of about 1 μm to about 10 μm, for example, 1 to 5 μm.

### Substrate

The substrate 1 may be porous. The substrate 1 may increase the permeability of the separator to increase the movement of lithium ions.

The substrate 1 may be or include a polymer film formed of or including any one polymer such as or including at least one of polyolefins such as polyethylene and polypropylene, polyesters such as polyethylene terephthalate and polybutylene terephthalate, polyacetal, polyamide, polyimide, polycarbonate, polyetheretherketone, polyaryletherketone, polyetherimide, polyamideimide, polybenzimidazole, polyethersulfone, polyphenylene oxide, cyclic olefin copolymers, polyphenylene sulfide, polyethylene naphthalate, glass fiber, and polytetrafluoroethylene such as Teflon, or a copolymer or mixture of two or more thereof.

In one example, the substrate 1 may be or include a polyolefin-based substrate including a polyolefin, for example, a polyethylene substrate.

The polyolefin-based substrate may have a desired or improved shutdown function, thereby contributing to improving the stability of the battery. The polyolefin-based substrate may be or include, for example, at least one of a polyethylene single-layer film, a polypropylene single-layer film, polyethylene/polypropylene two-layer film, a polypropylene/polyethylene/polypropylene three-layer film, and a polyethylene/polypropylene/polyethylene three-layer film. In addition, the polyolefin-based resin may include a non-olefin resin in addition to an olefin resin or include a copolymer of olefin and non-olefin monomers.

In an example, the polyolefin-based resin may have a weight average molecular weight of about 600,000 g/mol or more, for example, 600,000 to 4 million g/mol, or 600,000 to 3 million g/mol. Here, the weight average molecular weight may be obtained as a polystyrene-converted value by, e.g., gel permeation chromatography (GPC).

In one example, the polyolefin-based resin may have a melting temperature (Tm) in a range of about 130° C. to about 140° C. Here, Tm may be obtained by referring to a product catalog of a polyolefin-based material, or by methods known to those skilled in the art. For example, the melting temperature may be measured by the following method.

Using a DSC (device name: DSC Q20, manufacturer: TA Instruments), a polyethylene composition was heated to 200° C. at 10° C./min by increasing the temperature (Cycle 1), and isothermalized at 200° C. for 1 minute, cooled to 40° C. at 10° C./min, isothermalized at 40° C. for 1 minute, and then re-heated to 200° C. at 10° C./min (Cycle 2). In the DSC curve obtained therefrom, the temperature at the maximum point of the endothermic peak was measured as the melting temperature (Tm, ° C.), and the temperature at the maximum point of the exothermic peak was measured as the crystallization temperature (Tc, ° C.). In this case, the melting temperature (Tm) and the crystallization temperature (Tc) are expressed as the results measured in a section (Cycle 2) in which the second temperature increases and decreases.

The substrate may be manufactured by stretching an unstretched film containing the resin by a wet method. For example, the substrate may be manufactured by a filler extraction method, but is not limited thereto. The filler extraction method manufactures a porous substrate by a stretching process after mixing a polyolefin-based resin and a filler, extracting the filler after rolling, and forming pores. In an example, the stretching temperature may range from about 90 to about 130° C., for example, 90° C. to 110° C. In the above range, the sum of the tensile strength and the sum of elongation can be readily reached. In an example embodiment, the stretching ratio may range from 4 times to 10 times, for example, 5 to 8 times. In an example embodiment, the stretching may be performed by MD or TD uniaxial stretching, MD and TD biaxial stretching, or the like of the unstretched film.

The substrate 1 may have a thickness of about 10 μm or less, for example, a range of about 1 μm to about 10 μm, or 1 μm to 8 μm.

### Electrolyte:

The electrolyte includes a non-aqueous organic solvent, and the non-aqueous organic solvent has a volume ratio of ethylene carbonate (EC):dimethyl carbonate (DMC):ethyl methyl carbonate (EMC) in a range of about 20% to 30%: 30% to 40%: 30% to 40% based on the total volume of 100%.

During the operation of the battery, the adhesive layer of the separator may be in continuous contact with the electrolyte. During this process, the copolymer of the adhesive layer may dissolve in the electrolyte and form a film, which increases the change in the air permeability of the separator, thereby increasing resistance.

The non-aqueous organic solvent satisfying the above volume ratio can reduce the film formation of the adhesive layer and lower the change in air permeability after a long period of time when the separator of the rechargeable battery is impregnated.

When the content of ethylene carbonate is less than about 20% by volume, the copolymer can readily dissolve in the electrolyte, thereby increasing the resistance of the battery. When the content of ethylene carbonate exceeds about 30% by volume, there may be problems that the dissolution of the copolymer becomes severe, thereby significantly increasing the resistance of the battery and adhesion becomes excessively or substantially high, thereby causing the discharge capacity recovery rate to be poor when evaluating the lifetime of the battery and film formation occurs on the separator.

When the content of dimethyl carbonate is less than about 30% by volume, the adhesion of the adhesive layer in the separator is lowered because the offset of the adhesion by ethylene carbonate is not reduced, and thus the possibility of the adhesive layer being separated during the operation of the battery may be high, thereby lowering the reliability of the battery and increasing the change in the air permeability of the separator. When the content of dimethyl carbonate exceeds about 40% by volume, there may be a challenge in that film formation occurs on the separator.

When the content of ethyl methyl carbonate is less than about 30% by volume, the effect of delaying the dissolution of the copolymer by ethylene carbonate can be low or weak, thereby increasing the resistance of the battery and increasing the film formation and change in the air permeability of the separator. When the content of ethyl methyl carbonate exceeds about 40% by volume, there may be a challenge in that the change in the air permeability of the separator increases.

In one example embodiment, the non-aqueous organic solvent may have an EC:DMC:EMC volume ratio of about 20:40:40, about 30:30:40, or about 30:40:30 based on the total volume of 100%, for example, 20:40:40.

In one example embodiment, the non-aqueous organic solvent may have a total of ethylene carbonate and ethyl methyl carbonate in a range of about 55% to about 65% by volume, for example 55, 56, 57, 58, 59, 60, 61, 62, 63, 64, 65% by volume, based on the total volume of 100% by volume. In the above range, the film formation and the change in air permeability of the coating layer may be significantly low, thereby reducing or preventing an increase in the resistance of the battery and providing a long battery lifetime.

In one example, the mixture of ethylene carbonate, dimethyl carbonate, and ethyl methyl carbonate may be included in an amount of about 95 vol % or more, for example, in a range of about 95 vol % to about 100 vol %, or 100 vol % in the non-aqueous organic solvent. In the above range, there may be no electrolyte side reactions.

The electrolyte may include a lithium salt.

The lithium salt is a substance that dissolves in the non-aqueous organic solvent and acts as a source of lithium ions in the battery to enable the basic operation of a lithium rechargeable battery and promote the movement of lithium ions between a positive electrode and a negative electrode. Representative examples of the lithium salt may include one or more of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide (LiFSI), LiC₄F₉SO₃, LiN(CₓF₂ₓ₊₁SO₂)(C_{y}F_{2y+1}SO₂) (x and y are integers in a range from 1 to 20), lithium trifluoromethane sulfonate, lithium tetrafluoroethane sulfonate, lithium difluorobis(oxalato)phosphate (LiDFOBP), lithium difluoro (oxalato) borate (LiDFBOP) and lithium bis(oxalato) borate (LiBOB).

The lithium salt may be included in an amount in a range of about 0.1 M to about 2.0 M, for example, 0.5 to 1.5 M, for example, 1.0 to 1.7 M, in the electrolyte.

The electrolyte may further include a typical additive in addition to the non-aqueous organic solvent and the lithium salt.

The additive may include one or more of fluoroethylene carbonate (FEC), vinyl ethylene carbonate (VEC), and propylene sulfone (PS).

In one example, based on 100% by volume of the non-aqueous organic solvent, the FEC may be included in an amount in a range of about 5% to about 10% by volume, for example, 7% by volume, the VEC may be included in an amount in a range of 0.1% to 5% by volume, for example, 1% by volume, and the PS may be included in an amount in a range of 1% to 5% by volume, for example, 3% by volume.

Referring back to FIG. 1, the first electrode plate 112 may include a first electrode active material portion coated with a first electrode active material, and a first electrode tab 112a electrically connected to a first uncoated portion, which is an area that is not coated with the first electrode active material. The first electrode tab 112a may be or include a passage for current flow between the first electrode plate 112 and a first current collector (not shown). In some example embodiments, when the first electrode plate is manufactured, the first electrode tab 112a may be formed by being cut in advance to protrude to one side of the electrode assembly, or may protrude to one side of the electrode assembly more than the separator without separate cutting.

The second electrode plate 114 may include a second electrode active material portion coated with a second electrode active material, and a second electrode tab 114a electrically connected to a second uncoated portion, which is an area that is not coated with the second electrode active material. The second electrode tab 114a may be or include a passage for current flow between the second electrode plate 114 and a second current collector (not shown). In some example embodiments, when the second electrode plate is manufactured, the second electrode tab 114a may be formed by being cut in advance to protrude to the other side of the electrode assembly, or may protrude to the other side of the electrode assembly more than the separator without separate cutting.

The first electrode tab 112a and the second electrode tab 114a may be located on one surface in the same direction with respect to the electrode assembly 110. However, the present disclosure is not limited thereto. The first electrode tab 112a may be located on a left side surface of the electrode assembly 110, and the second electrode tab 114a may be located on a right side surface of the electrode assembly 110. Here, the left and right sides are for the sake of convenience of description based on the rechargeable battery shown in FIG. 1, and their positions may be changed when the rechargeable battery rotates horizontally or vertically.

The first electrode tab 112a and the second electrode tab 114a are electrically connected to the outside by being welded to a negative electrode lead 152 and a positive electrode lead 154 of an external terminal. A tab film 156 for insulation from the pouch 130 is attached to the negative electrode lead 152 and the positive electrode lead 154. The negative electrode lead 152, the positive electrode lead 154, and the tab film 156 may form an integrated tab film 150.

The sealing part 132 of the pouch 130 is formed of or include a heat fusion material and has a structure in which heat fusion layers are adhered to form a seal. Since the heat fusion material generally has weak adhesiveness to metal, the thin film-shaped tab film 156 is attached to the tab and fused with the pouch 130.

The first electrode plate 112 of the electrode assembly 110 may constitute a negative electrode, and the second electrode plate 114 may constitute a positive electrode. In another example, the reverse thereof is also possible.

Below, the positive and negative electrodes are described.

### Positive Electrode

A positive electrode for a rechargeable lithium battery may include a current collector, and a positive electrode active material layer on the current collector. The positive electrode active material layer may include a positive electrode active material, and may further include a binder and/or a conductive material. For example, the positive electrode may further include an additive that can constitute a sacrificial positive electrode.

### Positive Electrode Active Material

The positive electrode active material may include a compound (lithiated intercalation compound) that is capable of intercalating and deintercalating lithium. For example, at least one of a composite oxide of lithium and a metal such as or including at least one of cobalt, manganese, nickel, and combinations thereof may be used.

The composite oxide may be or include a lithium transition metal composite oxide. Examples of the composite oxide may include at least one of lithium nickel-based oxide, lithium cobalt-based oxide, lithium manganese-based oxide, lithium iron phosphate-based compound, cobalt-free lithium nickel-manganese-based oxide, or a combination thereof.

As an example, the following compounds represented by any one of the following Chemical Formulas may be used. LiₐA_{1-b}X_{b}O_{2-c}D_{c} (0.90≤a≤1.8, 0≤b≤0.5, and 0≤c≤0.05); LiₐMn_{2-b}X_{b}O_{4-c}D_{c} (0.90≤a≤1.8, 0≤b≤0.5, and 0≤c≤0.05); LiₐNi_{1-b-c}Co_{b}X_{c}O_{2-α}D_{α} (0.90≤a≤1.8, 0≤b≤0.5, 0≤c≤0.5, and 0<α<2); LiₐNi_{1-b-c}Mn_{b}X_{c}O_{2-α}D_{α} (0.90≤a≤1.8, 0≤b≤0.5, 0≤c≤0.5, and 0<α<2); LiₐNi_{b}Co_{c}L¹_{d}GₑO₂ (0.90≤a≤1.8, 0≤b≤0.9, 0≤c≤0.5, 0≤d≤0.5, and 0≤e≤0.1); LiₐNiG_{b}O₂ (0.90≤a≤1.8 and 0.001≤b≤0.1); LiₐCoG_{b}O₂ (0.90≤a≤1.8 and 0.001≤b≤0.1); LiₐMn_{1-b}G_{b}O₂ (0.90≤a≤1.8 and 0.001≤b≤0.1); LiₐMn₂G_{b}O₄ (0.90≤a≤1.8 and 0.001≤b≤0.1); LiₐMn_{1-g}G_{g}PO₄ (0.90≤a≤1.8 and 0≤g≤0.5); Li_{(3-f)}Fe₂(PO₄)₃ (0≤f≤2); or LiₐFePO₄ (0.90≤a≤1.8).

In the above Chemical Formulas, A is or includes at least one of Ni, Co, Mn, or a combination thereof; X is or includes at least one of Al, Ni, Co, Mn, Cr, Fe, Mg, Sr, V, a rare earth element or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

The positive electrode active material may be or include, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol %, and less than or equal to about 99 mol % based on 100 mol % of the metal excluding lithium in the lithium transition metal composite oxide. The high-nickel-based positive electrode active material may be capable of realizing high capacity, and can be applied to a high-capacity, high-density rechargeable lithium battery.

An amount of the positive electrode active material may be in a range of about 90 wt % to about 99.5 wt % based on 100 wt % of the positive electrode active material layer. Amounts of each of the binder and the conductive material may independently be in a range of about 0.5 wt % to about 5 wt %, respectively, based on 100 wt % of the positive electrode active material layer.

The binder attaches the positive electrode active material particles to each other, and attaches the positive electrode active material to the current collector. Examples of the binder may include at least one of polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may impart conductivity (e.g., electrical conductivity) to the electrode. Any material that does not cause chemical change in the battery (e.g., does not cause an undesirable chemical change in the rechargeable lithium battery) and that conducts electrons can be used. Examples of the conductive material may include a carbon-based material such as at least one of natural graphite, artificial graphite, carbon black, acetylene black, ketjen black, a carbon fiber, a carbon nanofiber, and carbon nanotube; a metal-based material containing at least one of copper, nickel, aluminum, silver, and the like, in a form of a metal powder or a metal fiber; a conductive polymer such as a polyphenylene derivative; or a mixture thereof.

Al may be used as the current collector, but the current collector is not limited thereto.

### Negative Electrode

The negative electrode for a rechargeable lithium battery may include a current collector, and a negative electrode active material layer on the current collector. The negative electrode active material layer may include a negative electrode active material, and may further include a binder and/or a conductive material (e.g., an electrically conductive material).

For example, the negative electrode active material layer may include a range of about 90 wt % to about 99 wt % of the negative electrode active material, a range of about 0.5 wt % to about 5 wt % of the binder, and a range of about 0 wt % to about 5 wt % of the conductive material.

### Negative Electrode Active Material

The negative electrode active material may include at least one of a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example, crystalline carbon, amorphous carbon or a combination thereof. The crystalline carbon may be graphite such as non-shaped, sheet-shaped, flake-shaped, sphere-shaped, or fiber-shaped, natural graphite or artificial graphite. The amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOx (0<x<2), a Si-Q alloy (where Q is or includes at least one of an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include at least one of Sn, SnO₂, a Sn-based alloy, or a combination thereof.

The silicon-carbon composite may be or include a composite of silicon and amorphous carbon. According to an example embodiment, the silicon-carbon composite may be in the form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles, and an amorphous carbon coating layer on a surface of the core.

The Si-based negative electrode active material or the Sn-based negative electrode active material may be used in combination with a carbon-based negative electrode active material.

The binder may attach the negative electrode active material particles to each other, and may attach the negative electrode active material to the current collector. The binder may include a non-aqueous binder, an aqueous binder, a dry binder, or a combination thereof.

The non-aqueous binder may include at least one of polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be or include at least one of a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include at least one of Na, K, or Li.

The dry binder may be or include a polymer material that is capable of being fibrous. For example, the dry binder may be or include at least one of polytetrafluoroethylene, polyvinylidene fluoride, a polyvinylidene fluoride-hexafluoropropylene copolymer, polyethylene oxide, or a combination thereof.

The conductive material may impart conductivity (e.g., electrical conductivity) to the electrode. Any material that does not cause chemical change in the battery (e.g., does not cause an undesirable chemical change in the rechargeable lithium battery) and that conducts electrons can be used. Non-limiting examples thereof may include a carbon-based material such as at least one of natural graphite, artificial graphite, carbon black, acetylene black, ketjen black, a carbon fiber, a carbon nanofiber, and a carbon nanotube; a metal-based material including at least one of copper, nickel, aluminum, silver, and the like, in a form of a metal powder or a metal fiber; a conductive polymer such as a polyphenylene derivative; or a mixture thereof.

The negative current collector may include at least one of a copper foil, a nickel foil, a stainless steel foil, a titanium foil, a nickel foam, a copper foam, a polymer substrate coated with a conductive metal, or a combination thereof.

As described above, the rechargeable battery is a pouch-type lithium ion rechargeable battery. However, the present disclosure is not limited thereto, and the rechargeable battery may be a cylindrical battery, a prismatic battery, or a pouch-type battery.

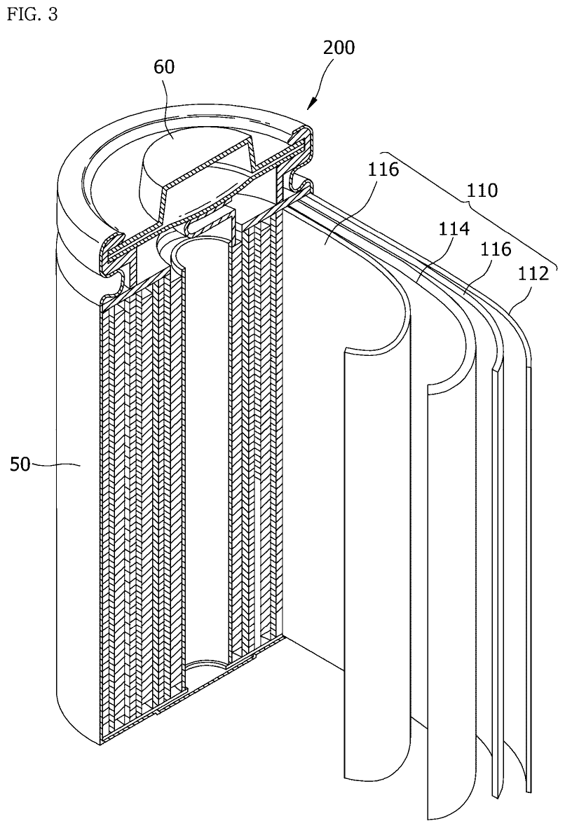

FIG. 3 is a perspective view of a cylindrical battery.

Referring to FIG. 3, the cylindrical battery 200 may include an electrode assembly 110 with a separator 116 interposed between a first electrode plate 112 and a second electrode plate 114, and a case 50 in which the electrode assembly 110 is embedded. The first electrode plate 112, the second electrode plate 114, and the separator 116 may be impregnated with an electrolyte (not shown). The cylindrical battery 200 may include a sealing member 60 that seals the case 50 as shown in FIG. 3.

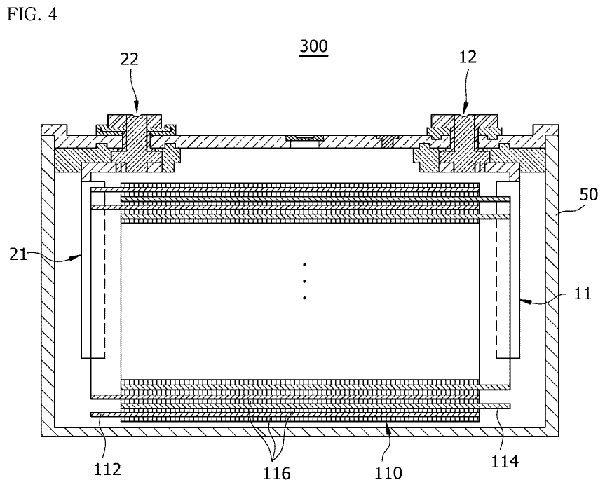

FIG. 4 is a perspective view of a prismatic battery.

Referring to FIG. 4, the prismatic battery 300 may include an electrode assembly 110 with a separator 116 interposed between a first electrode plate 112 and a second electrode plate 114, and a case 50 in which the electrode assembly 110 is embedded. The first electrode plate 112, the second electrode plate 114, and the separator 116 may be impregnated with an electrolyte (not shown). The prismatic battery 300 may include the case 50 as shown in FIG. 4. In FIG. 4, the prismatic battery 300 may include a positive electrode lead tab 11, a positive electrode terminal 12, a negative electrode lead tab 21, and a negative electrode terminal 22.

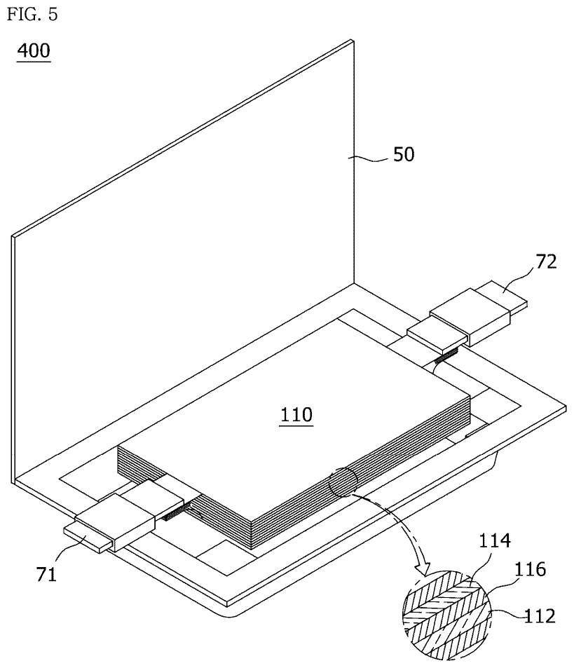

FIG. 5 is a perspective view of a pouch-type battery of another example embodiment.

Referring to FIG. 5, a pouch-type battery 400 may include an electrode assembly 110 with a separator 116 interposed between a first electrode plate 112 and a second electrode plate 114, and a case 50 in which the electrode assembly 110 is embedded. The first electrode plate 112, the second electrode plate 114, and the separator 116 may be impregnated with an electrolyte (not shown). In FIG. 5, the pouch-type battery 400 may include an electrode tab, that is, a positive electrode tab 71 and a negative electrode tab 72, which serve as an electrical passage for inducing a current generated in the electrode assembly 110 to the outside.

Hereinafter, examples and comparative examples of the present disclosure are described. However, the following examples are merely one example embodiment of the present disclosure, and the present disclosure is not limited to the following examples.

### Example 1

### Manufacture of Separator

A composition for forming a heat-resistant layer was prepared by dispersing boehmite (particle size D100: 2 μm, particle diameter D50: 0.3 μm, plate-shaped) in water and mixing an (meth)acryl-based binder.

A dispersion was prepared by dispersing a copolymer (glass transition temperature: 90° C.) of a monomer mixture including styrene and acrylic acid in a polar solvent (N-methyl-2-pyrrolidone (NMP), dimethylacetamide (DMA), or the like) and then milling and dispersing the mixture at 25° C. for 30 minutes using a bead mill. A composition for an adhesive layer was prepared by adding water so that the total solid content was 20 wt %.

A polyethylene film (weight average molecular weight of a polyethylene resin: 3 million g/mol, Tm: 132 to 136° C., thickness: 8 μm, manufactured by stretching) was used as a porous substrate.

A separator in which a heat-resistant layer (thickness: 5 μm) and an adhesive layer (thickness: 2 μm) were sequentially formed on each of both surfaces of the porous substrate was manufactured by coating both surfaces of the porous substrate with the composition for forming a heat-resistant layer, drying the composition for forming a heat-resistant layer at 70° C. for 10 minutes, and then coating the composition for forming a heat-resistant layer with the composition for an adhesive layer, and drying the composition for an adhesive layer at 70° C. for 10 minutes.

### Manufacture of Negative Electrode:

A negative electrode active material slurry for a negative electrode active material was prepared by mixing 90.4 wt % of graphite particles with the average particle diameter D50 of 13 μm, 7.1 wt % of a silicon-carbon composite, 1.5 wt % of a styrene-butadiene rubber (SBR) binder, and 1 wt % of carboxymethyl cellulose (CMC), adding the mixture to distilled water, and stirring the mixture for 60 minutes using a mechanical stirrer. A negative electrode was manufactured by applying the slurry on a 10 μm thick copper foil, drying the slurry in a hot air dryer at 100° C. for 0.5 hours, re-drying the slurry for 4 hours under vacuum and 120° C. conditions, and roll-pressing the copper foil on which the slurry was applied.

### Manufacture of Positive Electrode:

A positive electrode active material slurry was prepared by mixing 97.7 wt % of lithium cobalt nickel aluminum oxide (91 mol % of nickel) as a positive electrode active material, 1 wt % of carbon black powder as a conductive material, and 1.3 wt % of polyvinylidene fluoride (PVDF) as a binder, adding the mixture to a solvent, N-methyl-2-pyrrolidone, and stirring the mixture for 30 minutes using a mechanical stirrer. A positive electrode was manufactured by applying the slurry on a 15 μm thick aluminum foil, drying the slurry in a hot air dryer at 100° C. for 0.5 hours, re-drying the slurry for 4 hours under vacuum and 120° C. conditions, and roll-pressing the aluminum foil on which the slurry was applied.

### Manufacture of Battery:

The manufactured separator was located between the positive electrode and the negative electrode, and the stack of the positive electrode-separator-negative electrode-separator was rolled in the form of a jelly roll and added to a pouch-type case.

A pouch-type battery was manufactured by injecting 6 g of electrolyte (1.5 M LiPF₆ dissolved in non-aqueous organic solvents, that is, EC, DMC, and EMC at a volume ratio of 20:40:40 based on the total volume of 100) to completely immerse the stack in the electrolyte, sealing the battery, charging and discharging the battery, and leaving the battery at 25° C. for 12 hours and at 60° C. for 24 hours.

### Example 2

A pouch-type battery was manufactured by the same method as in Example 1, except that the non-aqueous organic solvent in the electrolyte were changed as shown in Table 1 below.

### Examples 3 to 5

Pouch-type batteries were manufactured by the same method as in Example 1, except that a copolymer of styrene and acrylic acid which glass transition temperature was changed as shown in Table 1 below was used instead of the copolymer of styrene and acrylic acid (glass transition temperature: 90° C.) in Example 1. The glass transition temperature was achieved by changing the mol % range of styrene and acrylic acid among the monomers.

### Comparative Examples 1 to 4

Pouch-type batteries were manufactured by the same method as in Example 1, except that a copolymer of styrene and acrylic acid which glass transition temperature was changed as shown in Table 1 below was used instead of the copolymer of styrene and acrylic acid (glass transition temperature: 90° C.) in Example 1. The glass transition temperature was achieved by changing the mol % range of styrene and acrylic acid among the monomers.

### Comparative Examples 5 to 10

Pouch-type batteries were manufactured by the same method as in Example 1, except that in Example 1, 1.5 M LiPF₆ dissolved in non-aqueous organic solvents, that is, EC, DMC, and EMC as an electrolyte was included, and the volumes of EC, DMC, and EMC were changed as shown in Table 1 below based on the total volume of 100.

The following physical properties were evaluated for the batteries of the examples and comparative examples.

### Discharge Capacity Recovery Rate of Battery (Units: %)

The batteries manufactured in the examples and comparative examples were repeatedly subjected to 0.8 C CC/CV charging (4.3 V, 0.05 C CUT-OFF) and 0.8 C CC discharging (4.3 V CUT-OFF) three times at 25° C. to measure a discharge capacity at the third cycle. A discharge capacity was measured after 150 cycles.

The discharge capacity recovery rate was calculated as (discharge capacity after 150 cycles)/(discharge capacity at third cycle)×100.

### Adhesion of Separator (Units: %)

The adhesion of the separator was measured using a single column (Instron-3344).

The batteries manufactured in the examples and comparative examples were pressed at high temperature and high pressure and were left at room temperature (25° C.) for 1 day, and then the positive electrode-separator-negative electrode was removed. For the samples of the positive electrode-separator-negative electrode, which was removed, a jig provided with a load cell with a maximum load of 1 kN was connected to each of the separator and the positive electrode, and the adhesion between the positive electrode and the separator was measured while the positive electrode and the separator were peeled at 180° at a speed of 100 mm/min.

The adhesion measured in the examples and comparative examples was expressed as a ratio (percentage) with respect to the adhesion measured for Example 1. The adhesion percentage may preferably be 80% or more for battery reliability.

### Change in Air Permeability of Separator (Units: %)

An air permeability T1 of the separator was measured for the batteries manufactured in the examples and comparative examples.

After the batteries were left at room temperature for 7 days, the separator was removed and an air permeability T2 was measured by the same method as above. The air permeability was measured by a method of measuring the time (units: seconds) it took for 100 cc of air to pass through the separator using a measurement device (EG01-55-1MR, Asahi Seiko).

### Air Permeability Measurement Device Setting Conditions:

Measurement pressure: 0.5 kg/cm², cylinder pressure: 2.5 kg/cm², set time: 10 seconds

The change in air permeability was calculated as (T2−T1)/T1×100. The change in air permeability may be preferably 10% or less for battery reliability.

### Film Formation of Separator

The batteries manufactured in the examples and comparative examples were left at room temperature for 7 days. The separator was removed from the battery and a surface image was observed using a Scanning Electron Microscope (SEM). A case in which film formation did not occur on the separator was evaluated as ⊚, a case in which film formation occurred on ¼ of the separator was evaluated as ∘, a case in which film formation occurred on more than ¼ and ½ or less of the separator was evaluated as Δ, and a case in which film formation occurred on more than ½ of the separator was evaluated as X.

### Resistance (Units: Ω)

A coin cell was manufactured using the stacks of the positive electrode-separator-negative electrode-separator manufactured in the examples and comparative examples, and then evaluated using an electrochemical impedance spectroscopy (EIS) measurement method.

TABLE 1

| | | | | | Discharge | | | Film | |
|---|---|---|---|---|---|---|---|---|---|
| | | | | | capacity | | Change in | formation | |
| | | Electrolyte | | | recovery | | air | of | |
| | Tg | EC | DMC | EMC | rate | Adhesion | permeability | separator | Resistance |
| Example 1 | 90 | 20 | 40 | 40 | 98.7 | 100 | 7 | ⊚ | 0.80 |
| Example 2 | 90 | 30 | 40 | 30 | 96.0 | 140 | 10 | ◯ | 1.06 |
| Example 3 | 110 | 20 | 40 | 40 | 98.1 | 80 | 5 | ⊚ | 0.73 |
| Example 4 | 130 | 20 | 40 | 40 | 96.9 | 80 | 5 | ⊚ | 0.74 |
| Example 5 | 150 | 20 | 40 | 40 | 95.3 | 80 | 5 | ⊚ | 0.70 |
| Comparative | 30 | 20 | 40 | 40 | 93.2 | 500 | 50 | X | 1.60 |
| Example 1 | | | | | | | | | |
| Comparative | 60 | 20 | 40 | 40 | 96.1 | 200 | 27 | X | 1.20 |
| Example 2 | | | | | | | | | |
| Comparative | −10 | 20 | 40 | 40 | 87.1 | 600 | 73 | X | 1.70 |
| Example 3 | | | | | | | | | |
| Comparative | 160 | 20 | 40 | 40 | 95.0 | 430 | 5 | ◯ | 0.70 |
| Example 4 | | | | | | | | | |
| Comparative | 90 | 10 | 80 | 10 | 94.9 | 170 | 15 | Δ | 1.20 |
| Example 5 | | | | | | | | | |
| Comparative | 90 | 40 | 20 | 40 | 94.0 | 200 | 30 | X | 1.34 |
| Example 6 | | | | | | | | | |
| Comparative | 90 | 20 | 20 | 60 | 98.0 | 80 | 10 | ◯ | 0.75 |
| Example 7 | | | | | | | | | |
| Comparative | 90 | 20 | 50 | 30 | 96.4 | 110 | 11 | Δ | 1.02 |
| Example 8 | | | | | | | | | |
| Comparative | 90 | 20 | 60 | 20 | 95.9 | 140 | 15 | Δ | 1.27 |
| Example 9 | | | | | | | | | |
| Comparative | 90 | 20 | 30 | 50 | 98.2 | 80 | 10 | ◯ | 0.77 |
| Example 10 | | | | | | | | | |

As shown in Table 1 above, the lithium rechargeable batteries of the examples had less film formation of the adhesive layer in the separator after a long period of time in the battery and a low change the air permeability of the separator. Accordingly, it can be observed that the discharge capacity recovery rate of the battery was high and resistance was low. In addition, it can be observed that the lithium rechargeable batteries of the examples secured an appropriate range of adhesion even after the separator was impregnated with the electrolyte.

However, as shown in Table 1 above, it can be observed that the effects of the examples cannot be obtained in the same electrolyte when the glass transition temperature of the copolymer in the adhesive layer is less than 90° C. or is more than 150° C. In addition, as shown in Table 1 above, it can be observed that the effects of the examples cannot be obtained even when the composition of the electrolyte deviates from the composition of the present disclosure.

According to one example embodiment, a rechargeable battery having an extended lifetime is provided by reducing or preventing an increase in the resistance of a separator by reducing the film formation of an adhesive layer of the separator within the battery.

According to another example embodiment, a rechargeable battery having desired or improved reliability is provided by reducing a change in the air permeability of a separator within the battery, and thereby extending the lifetime of the separator.

According to still another example embodiment, a rechargeable battery having desired or improved manufacturing processability is provided by reducing or preventing adhesion between separators and separation of an adhesive layer from the separator.

Although example embodiments of the present disclosure have been described above, the present disclosure is not limited thereto and may be modified into various forms within the scope of the claims, the detailed description of the present disclosure, and the accompanying drawings, and the modifications also fall within the scope of the present disclosure.

What is claimed is:

1. A rechargeable battery comprising:
an electrode assembly including a first electrode plate, a second electrode plate, and a separator interposed between the first electrode plate and the second electrode plate; and
an electrolyte with which the electrode assembly is impregnated,
wherein the separator includes a substrate and an adhesive layer located on at least one surface of the substrate, the adhesive layer includes a copolymer of a monomer mixture including an unsaturated monomer having a carboxylic acid group or a salt thereof and an unsaturated monomer having an aromatic group, and the copolymer has a glass transition temperature in a range of about 90° C. to about 150° C., and
the electrolyte includes a non-aqueous organic solvent, and the non-aqueous organic solvent has an ethylene carbonate:dimethyl carbonate:ethyl methyl carbonate volume ratio in a range of about 20% to 30%:30% to 40%:30% to 40% based on a total volume of 100%.

2. The rechargeable battery of claim 1, wherein the unsaturated monomer having a carboxylic acid group or a salt thereof is represented by any one of Chemical Formulas 1 to 3: 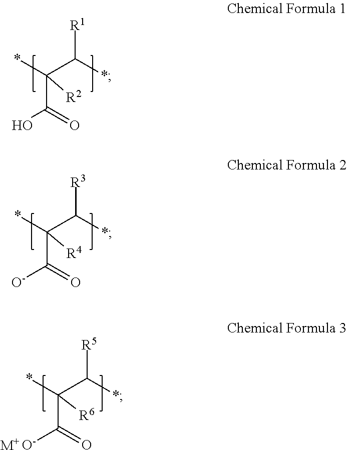
wherein:
* is a connecting portion of an element,
R¹ to R⁶ are each independently hydrogen or a C1 to C10 alkyl group, and
M comprises an alkali metal.

3. The rechargeable battery of claim 1, wherein the unsaturated monomer having an aromatic group is represented by Chemical Formula 5: 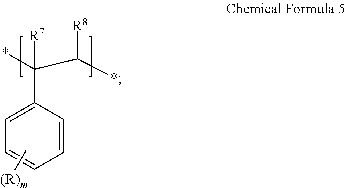
wherein:
* is a connecting portion of an element,
R⁷ and R⁸ are each independently hydrogen or a substituted or unsubstituted C1 to C5 alkyl group,
R comprises at least one of a substituted or unsubstituted C1 to C20 alkyl group, a substituted or unsubstituted C3 to C20 cycloalkyl group, a substituted or unsubstituted C1 to C20 alkoxy group, a substituted or unsubstituted C3 to C20 aryl group, a halogen, and a substituted or unsubstituted C2 to C20 alkenyl group, and
m is an integer ranging from 0 to 5.

4. The rechargeable battery of claim 1, wherein a mixture of the unsaturated monomer having a carboxylic acid group or a salt thereof and the unsaturated monomer having an aromatic group is included in an amount of about 50 mol % or more in the monomer mixture.

5. The rechargeable battery of claim 1, wherein the monomer mixture further comprises a (meth)acryl-based monomer.

6. The rechargeable battery of claim 5, wherein the (meth)acryl-based monomer is represented by Chemical Formula 6: 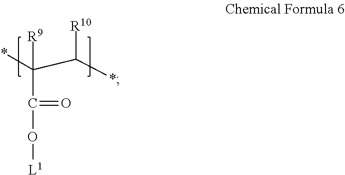
wherein:
* is a connecting portion of an element,
R⁹ and R¹⁰ are each independently hydrogen or a methyl group, and
L¹ comprises a substituted or unsubstituted, straight-chain or branched-chain C1 to C10 alkyl group.

7. The rechargeable battery of claim 5, wherein a mixture of the unsaturated monomer having a carboxylic acid group or a salt thereof, the unsaturated monomer having an aromatic group, and the (meth)acryl-based monomer is included in an amount of about 95 mol % or more in the monomer mixture.

8. The rechargeable battery of claim 1, wherein the copolymer comprises a copolymer of (meth)acrylic acid and styrene.

9. The rechargeable battery of claim 1, wherein the copolymer comprises a copolymer of (meth)acrylic acid, styrene, and n-butyl (meth)acrylate.

10. The rechargeable battery of claim 1, wherein the copolymer is a particle-type binder having an average particle diameter (D50) in a range of about 0.1 μm to about 1.0 μm.

11. The rechargeable battery of claim 1, wherein a heat-resistant layer is further stacked between the substrate and the adhesive layer, and
the heat-resistant layer includes a filler.

12. The rechargeable battery of claim 11, wherein the filler is included in an amount of about 50 wt % or more in the heat-resistant layer.

13. The rechargeable battery of claim 11, wherein the filler has an average particle diameter (D50) in a range of about 20 nm to about 300 nm.

14. The rechargeable battery of claim 1, wherein the electrolyte comprises a lithium salt at a range of about 0.1 M to about 2.0 M.

15. The rechargeable battery of claim 1, the rechargeable battery comprising a pouch-type battery.
